(19) United States
(12) Patent Application Publication
(10) Pub. No.: US 2009/0107178 A1
(43) Pub. Date: Apr. 30, 2009

(54) Method for manufacturing tempered glass bathroom fixtures

(76) Inventors: Jose Ruben Chables Sandoval, San Diego, CA (US); Ismael del Pino Bermejo, San Diego, CA (US)

Correspondence Address: George T. Parsons, 2736 Aegean Drive, San Diego, CA, 92139-3211, US

(21) Appl. No.: 11/977,492

(22) Filed: Oct. 25, 2007

(51) Int. Cl. C03C 19/00

(52) U.S. Cl. 65/61

(57) ABSTRACT

The present invention is a manufacturing process to create tempered glass bathroom fixtures. Some of those fixtures include glass toilets, urinals, and bidets. The major steps in sequence are: 1) batching step, 2) melting step, 3) glass pressing step, 4) finishing step, 5) tempering step, 6) grinding step, 7) final assembly, and 8) polishing step. Embodiments include the weight percentage of elements used to create a particular fixture. Another embodiment provides a safe tempered fixture that is durable and strong to withstand the weight of a human. In addition, within each embodiment are other embodiments specific to unique colors and shading of a fixture. The shading relates to the difference in shade between the upper portions of toilets, urinals, and bidets, and the lower bowl-like portion A unique design feature of the process provides for a darkened translucent color in the bowl-like region.

### BACKGROUND OF THE INVENTION

1. Field of the Invention

The present invention relates generally to tempered glass devices, and, more specifically, to the manufacturing process to make tempered glass bathroom fixtures. Some of those fixtures include glass toilets, urinals, and bidets.

2. Description of the Related Art

Toilets, urinals, or bidets are part of the most necessary rooms in our houses, organizations, or businesses. However, current colors and designs limit creativity in our bathrooms or restrooms.

Homeowners prefer their bathrooms to be both beautiful and functional. Therefore, manufacturers have responded with many choices in fixtures and designs but have not been able to create a novel appearance that is also beautiful. Indeed, manufacturers have designed toilets, urinals, and bidets that wash and dry you with water jet sprays, play music, detect humans nearby with infrared sensors and automatically raise and lower their lids.

Businesses prefer easy to clean and easy to maintain fixtures. In addition, they normally want the best value for their investment. A tendency is to install white fixtures to imply sanitary conditions. Nevertheless, the color is no guarantee of cleanliness. In fact, typically white fixtures show dirt, urine, or other unclean conditions easier that colors. So the public or employees will quickly notice uncleanliness and form a less than positive opinion of the business. Consider the ubiquitous knowledge of filthy roadside bathrooms in gas stations or rest stops.

Organizations such as hotels and motels, or up scale stores focus on ways to differentiate themselves from competition. One way is to have spotless bathrooms or restrooms. Here again, industry standards provide typically white fixtures that do not differentiate from competitors.

Homeowners, businesses, and other organizations need and want toilet, bidet, and urinal designs and colors that not only look beautiful, but also that match with the great taste and styling details to the rest of their houses or organizations.

Nowadays, the most commonly toilets, urinals, and bidets used are made from ceramic, vitro china, porcelain, rock, plastic, or stainless steel, and finished with colors such as white, black, yellow, brown, or green. Major fixture distributors in the U.S. are Kohler, American Standard, and Newport Brass.

The current bathroom fixture designs and colors have some major disadvantages. Unfortunately, current bathroom fixtures are not attractive in design or color. For many years in most countries, the basic designs and colors are the same. For example, every bathroom toilet, urinal, and bidet looks the same. No differentiation is practically available to homes, businesses, or organizations. However, by spending large sums of money, some differentiation is possible for such items as tile, doors, and small fixtures but not the toilet, urinal, or bidet.

Therefore, it is an object of the present invention to provide a novel manufacturing process for glass bathroom fixtures to eliminate the above mentioned disadvantages. One objective of the present invention is to provide color to the manufacturing process to provide fixtures that can be beautiful and enhancing to the decor of the bathroom or restroom. Another objective of the present invention is to provide a durable fixture that is stronger than current designs. Still another objective is to provide a manufacturing process that is equivalent or lower in cost to current processes. And yet another objective is to provide multiple embodiments of chemical combinations to create a wide variety of colors, and shades in bathroom fixtures. To date, to the knowledge of the Applicants, no such process has been invented. The Applicants think the present invention overcomes a long-standing, and even ignored opportunity, that has resulted in foregoing billions of dollars in sales through replacement fixtures and new markets in the bathroom fixture industry.

### SUMMARY OF THE INVENTION

The above-mentioned difficulties and problems are overcome by the present invention. The present invention is a manufacturing process to create tempered glass bathroom fixtures. Some of those fixtures include glass toilets, urinals, and bidets. The novel use of tempered glass provides a large number of designs and color options previously unavailable to users. Now bathrooms will have an attractive appearance at an economical cost.

Dimensions are not shown but they are typical of most toilets, urinals, and bidets. The beauty of glass is natural and does not need a complex exterior design to make it look clean and beautiful. Applicants suggest that the present invention for glass toilets, urinals, and bidets makes people perceive them as pieces of art, or decorative furniture, in addition to bathroom articles, because they look beautiful.

The novel manufacturing process uses a typical tempered glass manufacturing process as a model. However, unique features are incorporated in the present invention. The major steps in sequence are: 1) batching step, 2) melting step, 3) glass pressing step, 4) finishing step, 5) tempering step, 6) grinding step, 7) final assembly, and 8) polishing step.

More specifically, but in summary, the present invention includes both operable and preferred embodiments In the batching step, these embodiments are unique in their weight percentage of elements used to create a particular fixture. The design incorporates novel combinations of elements to manufacture a tempered fixture that is durable to withstand the weight of a human and to prevent breakage in general. In addition, within each embodiment are other embodiments specific to unique colors and shading of a fixture. The shading relates to the difference in shade between the upper portions of toilets, urinals, and bidets, and the lower bowl-like portion A unique design feature of the process provides for a darkened translucent color in the bowl-like region to prevent viewing particulates and wastes.

In the melting step, cullet is added to the melt acting as a fluxing agent and accelerating the melting of the sand. “Cullet” is defined as crushed or waste glass used in remelting or recycling. Then the molten glass is carried through a series of distribution channels to the forming machines and molds. At the end of the distribution channels, the glass flow is cut into gobs, or molten glass, whose weight, shape, and temperature are precisely controlled and then also controlled to fill the molds completely.

In the forming step, the molds are warmed to a temperature of approximately, but no more than, 1,000 degrees F., before the molten glass is fed into them. The molten glass is then pressed into the pattern of the desired bathroom fixture mold. The gob is transformed by pressing or blowing into an intermediate hollow pocket shape, with the opening fully formed. The whole forming cycle only takes a few seconds.

In the finishing step, the glass object is taken out of the mold after one to five minutes, to display the newly formed glass toilet, urinal, or bidet. Within 10 minutes, all finishing operations are performed while the glass is still malleable.

Next is the tempering step. Tempering reduces the likelihood of serious injury on impact. Tempering also increases the ability of glass to survive the impact of objects that may strike the bathroom fixture. Therefore this tempering step qualifies as a safety step. Since a person sits on a toilet or bidet when using them, in this novel process, these fixtures are manufactured in at least two separate pieces.

Next, some details of the tempering process are explained. A complementary coating is added to each fixture when it is cooling at the lehr exit. Once the fixture has completed the finishing step, it is placed in a cooling place. Here, an air jet system rapidly cools the fixture in order to temper the glass.

Next is the grinding step. The only work that can be performed on tempered glass is grinding to reduce the width and length in certain fixtures to meet quality specifications.

Then, the final assembly step is conducted. Some of the parts of the toilet, urinal, and bidet are manufactured in different molds for safety reasons as discussed before. In this final assembly step, the separate parts are joined. These parts are internal assemblies and will not affect the surface aesthetic or appearance of the fixtures.

Finally, the polishing step is conducted. Each fixture goes through a glazer to fire the glass and melt off the outermost layer, leaving it with a smooth, shiny finish. This step completes the manufacturing process for the present invention.

Key novel features or advantages include manufacturing from glass. No one, to Applicants' knowledge, has made these large bathroom fixtures from glass. Another novel feature is the adding color in many different colors and shades. Still another unique feature is the darker shading lower areas of toilets, urinals, and bidets by molding the fixtures to be thicker. Yet another novel feature of the present invention is the specific weight percentages of raw material and coloring agents.

These, and other, novel features and advantages of the present invention are set forth more completely in the accompanying drawings and the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Details of the invention, and of the preferred embodiments thereof, will be further understood upon reference to the drawings, wherein closely related elements have the same number but different alphabetical suffixes, and further wherein:

FIG. 1 is a perspective view of a preferred embodiment of a glass toilet manufactured from the present invention,

FIG. 2 is a perspective view of a preferred embodiment of a glass urinal manufactured from the present invention,

FIG. 3 is a perspective view of a preferred embodiment of a glass bidet manufactured from the present invention,

FIG. 4 is a representative glass bathroom fixture manufacturing process flow chart,

FIG. 5 is a table of a preferred glass composition with multiple embodiments of colorant agents,

FIG. 6 is a table of a more preferred glass composition with multiple embodiments of colorant agents, and

FIG. 7 is a table of considerations for adding colorant agents.

### DETAILED DESCRIPTION OF THE PREFERRED EMBODIMENTS

The above-mentioned difficulties and problems are overcome by the present invention. The present invention is a manufacturing process 400 to create tempered glass bathroom fixtures. Some of those fixtures include glass toilets, urinals, and bidets. The novel use of tempered glass provides a large number of designs and color options previously unavailable to users. Now bathrooms will have an attractive appearance at an economical cost.

The novel manufacturing process 400 uses a typical tempered glass manufacturing process as a model. Yet, novel changes are made to the model process. Most of the time, people think of transparent glass. Also, glass is considered my many people as fragile. However, we know glass comes in many different colors, not just white or transparent. Bathrooms are designed for compactness, or in standard orientation of fixtures. Applicants believe the present invention is not obvious because it does not currently exist, even after thousands of years of glass manufacturing, and hundreds of years of bathroom fixtures. Nevertheless, the concept is easy to understand. More specifically, the present invention includes both preferred and more preferred embodiments.

Referring first to FIG. 1, a perspective view of a preferred embodiment is shown of a glass toilet 100 manufactured from the present invention.

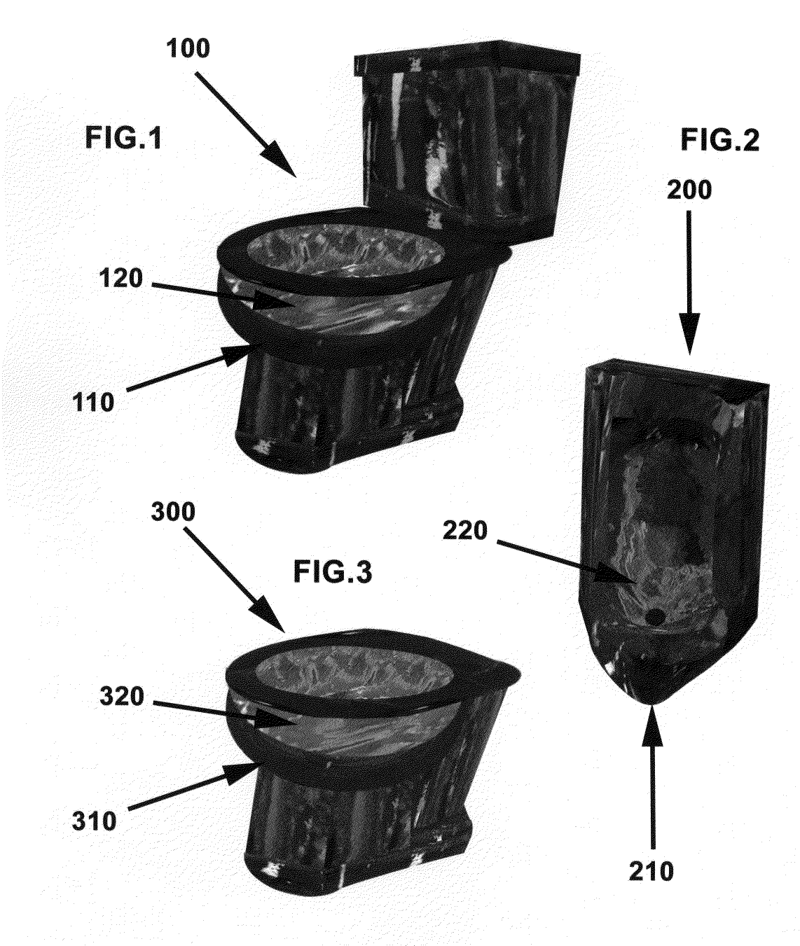

Referring next to FIG. 2, a perspective view of a preferred embodiment is shown of a glass urinal 200 manufactured from the present invention.

Now referring to FIG. 3, a perspective view of a preferred embodiment is shown of a glass bidet 300 manufactured from the present invention.

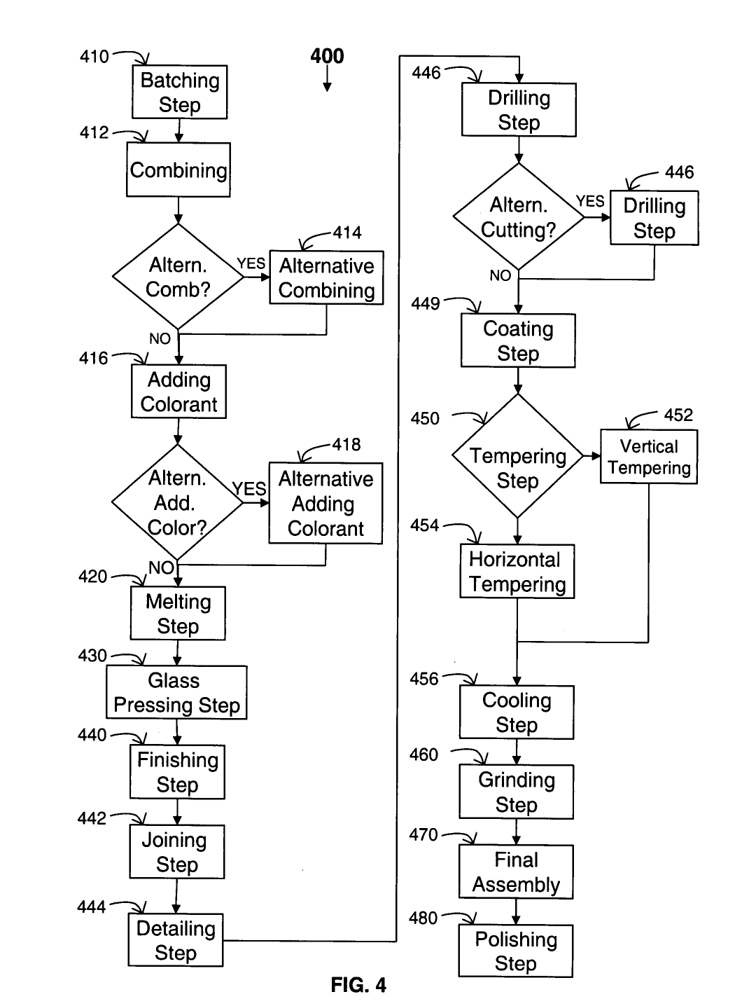

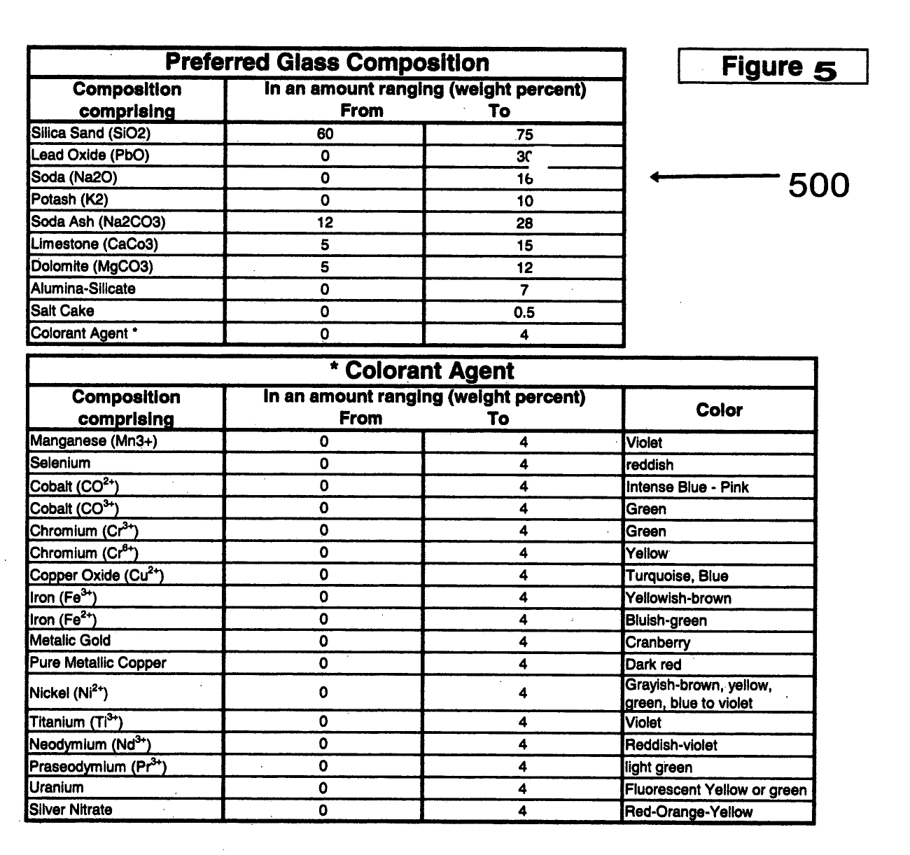

Continuing with FIG. 4, a representative glass bathroom fixture manufacturing process 400 is described. Eight major steps are now described. A method of operation of manufacturing tempered glass fixtures comprises the major sequential steps of: 1) batching step 410, 2) melting step 420, 3) glass pressing step 430, 4) finishing step 440, 5) tempering step 450, 6) grinding step 460, 7) final assembly 470, and 8) polishing step 480.

The first step is the batching step 410. In the batching step 410, these embodiments are unique in their weight percentage of elements used to create a particular fixture. The design incorporates novel combinations of elements to manufacture a tempered fixture that is durable to withstand the weight of a human and to prevent breakage in general. In addition, within each embodiment are other embodiments specific to unique colors and shading of a fixture. The shading relates to the difference in shade between the upper portions of toilets, urinals, and bidets, and the lower bowl-like portion A unique design feature of the process 400 provides for a darkened translucent color in the bowl-like region to prevent viewing particulates and wastes.

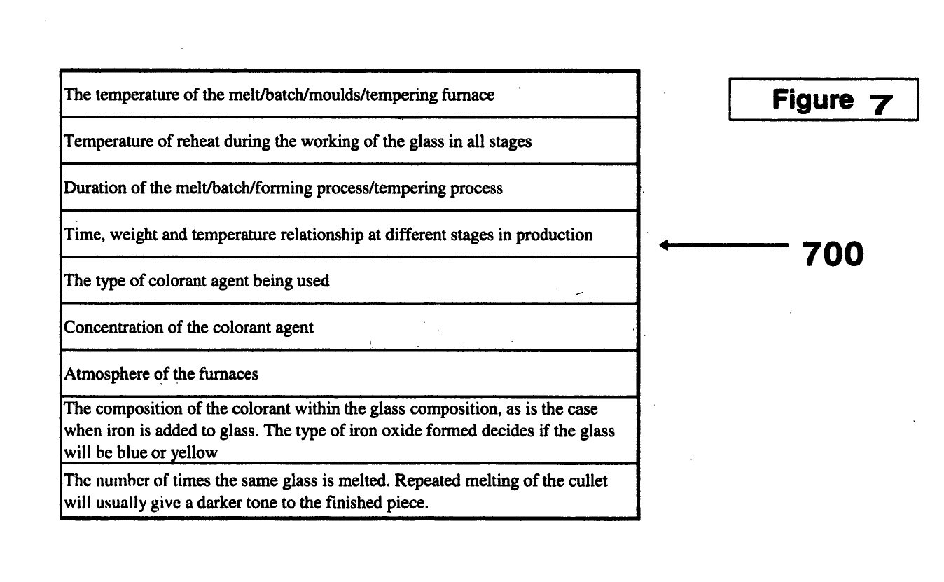

The batching step 410 of the manufacturing process 400 further comprises the following steps. A preferable combining step 414 is combining the following chemical compounds as shown in FIG. 6 from the specified weight percentage ranges: silica sand (SiO₂) 50-75%, lead oxide (PbO) 0-30%, soda (Na₂O) 0-16%, Potash (K₂) 0-10%, soda ash (Na₂Co₃) 12-28%, limestone (CaCo₃) 5-15%, dolomite (MgCo₃) 5-12%, alumina-silicate 0-7%, salt cake 0-0.5%, and a colorant agent 0-4%.

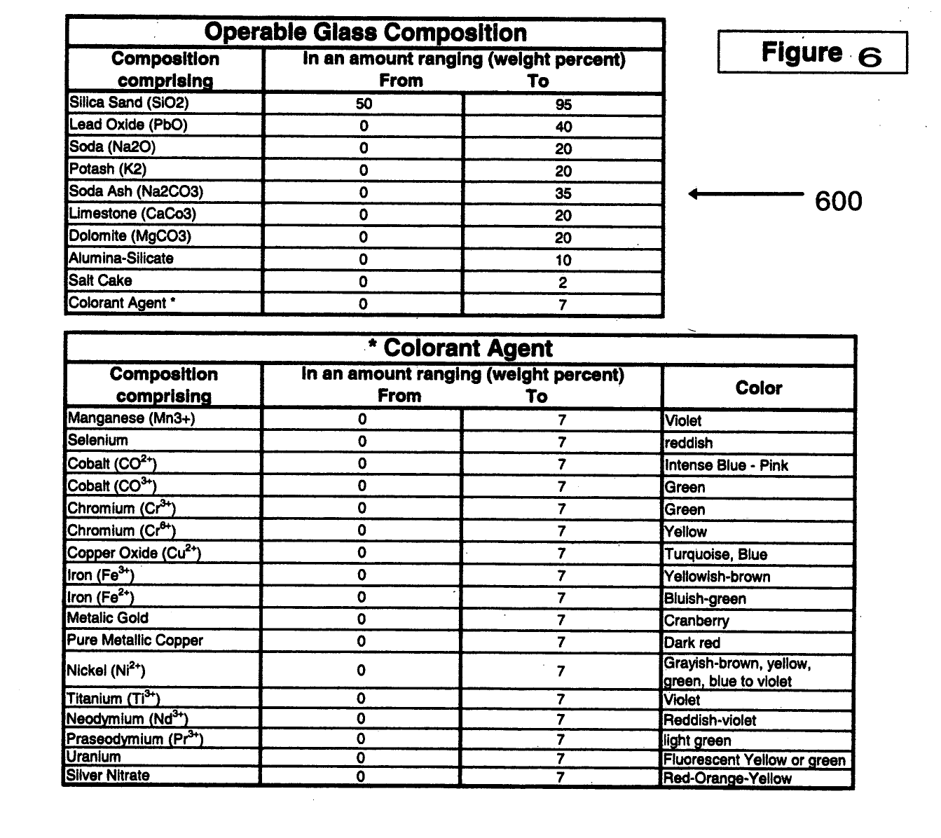

Alternatively, A second and more preferable combining step 412 is combining the following chemical compounds as shown in FIG. 5 from the specified weight percentage ranges: silica sand (SiO₂) 50-95%, lead oxide (PbO) 0-40%, soda (Na₂O) 0-20%, Potash (K₂) 0-20%, soda ash (Na₂Co₃) 0-35%, limestone (CaCo₃) 0-20%, dolomite (MgCo₃) 0-20%, alumina-silicate 0-10%, salt cake 0-2%, and a colorant agent 0-7%.

An adding colorant step 416 is adding a colorant from a listing of possible colorant agents as shown in FIG. 5. More specifically, and by way of example, for a turquoise shade of a bathroom fixture, copper oxide (Cu2) is added in the weight percentage 0-5%.

An alternative preferable adding colorant step 418 is adding a colorant from a listing of possible colorant agents as shown in FIG. 6. More specifically, and by way of example, for a turquoise shade of a bathroom fixture, copper oxide (Cu₂) is added in the weight percentage 0-3%.

The second step is the melting step 420. In the melting step, cullet is added to the melt acting as a fluxing agent and accelerating the melting of the sand. “Cullet” is defined as crushed or waste glass used in remelting or recycling. In a furnace, the mixture of all materials is raised to a melting point of 2,500 degrees F. Then the molten glass is carried through a series of distribution channels to the forming machines and molds. At the end of the distribution channels, the glass flow is cut into gobs, or molten glass, whose weight, shape, and temperature are precisely controlled and then also controlled to fill the molds completely.

The third step is the glass pressing step 430, or forming step. In the pressing step 430, the molds are warmed to a temperature of approximately, but no more than, 1,000 degrees F., before the molten glass is fed into them. At this point in the manufacturing process 400, the molten glass is approximately 1,000-1,300 degrees F. depending on the product and colors. The molten glass is then pressed into the pattern of the desired bathroom fixture mold. For the toilet and urinal fixtures, one to ten different molds are used depending on the design of each one, and one to five molds for the bidet fixture. The design of a mold for the lower bowl area of the toilet is larger than the upper portion. Therefore the glass in the lower bowl portion is thicker than the upper portion. As the glass gets thicker, the density of the color also increases. This causes the glass to transmit less visible light. The light transmittance of tinted glass varies from 14 to 83 percent depending upon its color and thickness. The shading relates to the difference in shade between the upper portions of toilets, urinals, and bidets, and the lower bowl-like portion. This unique design feature of the process provides for a darkened translucent color in the bowl-like region to prevent viewing particulates and wastes. Molds can be made from bronze, metal, iron, stainless, alloy, or nickel. The gob is transformed by pressing or blowing into an intermediate hollow pocket shape, with the opening fully formed. The whole forming cycle only takes a few seconds.

The fourth step is the finishing step 440. In this finishing step 440, the glass object is taken out of the mold after one to five minutes, to display the newly formed glass toilet, urinal, or bidet. The glass is still at temperatures of over 1,060 degrees F. when it comes out of the mold. Then it is held briefly over a cooling plate before being conveyed away. Within 10 minutes, all finishing operations are performed while the glass is still malleable.

Some of those operations include, but are not limited to, a joining step 442 to join the parts of one fixture that were manufactured in different molds, a detailing step 444 for the edges and union areas, as well as a drilling step 446 or a cutting step 448 where necessary. To make the glass toilets, urinals, and bidets more resistant to scratches, a coating step 449 provides the fixtures with a surface coat applied when the fixtures are still hot.

The fifth step is the tempering step 450. Some discussion of the tempering process is appropriate now, before details of this step are explained. Tempered glass is manufactured through a process of extreme heating and rapid cooling, making the glass harder than normal glass. Walls and parts of the glass toilet, urinal, and bidet undergo a strengthening process in order to support its own structure and human weight. Tempered glass cannot be cut, drilled or edged. Glass is tempered for safety reasons because tempered glass, if broken, is designed to shatter into cube-shaped particles. Tempering also increases the ability of glass to survive the impact of objects that may strike the bathroom fixture. Therefore this tempering step qualifies as a safety step.

Tempered glass has the following strength characteristics: Typical Breaking Stress (large light 60 sec. load)=24,000 psi. The Typical Impact Velocity Causing Fracture (¼″ light 5 gm missile, impact normal surface)=60 ft/sec. In other words, tempered glass is four to five times stronger than standard glass. Although it is quite rare that tempered glass gets broken, when it does break, the entire piece gets broken. Since a person sits on a toilet or bidet when using them, in this novel process, these fixtures are manufactured in at least two separate pieces.

Next, some details of the tempering step 450 are explained. A complementary coating is added to each fixture when it is cooling at the lehr exit. The lehr (or leer) is an annealing furnace for glass. During annealing, the glass is first heated in the melting step 420, then later cooled in this tempering step 450 to fix the novel color in the glass fixture. Depending on the fixture, one of two additional secondary steps to temper the glass are now used, a vertical tempering step 452 or horizontal tempering step 454. In vertical tempering 452, large tongs are used to suspend the glass fixture from its top edge. The fixture moves vertically through the furnace in this manner. In horizontal tempering 454, the glass moves through the furnace on stainless steel or ceramic rollers.

Next a cooling step 456 occurs. Here, an air jet system rapidly cools the fixture in order to temper the glass. This cooling step 456 blows air uniformly onto all fixture surfaces simultaneously. This cooling is known as air quenching. The immediate and sustained application of an air quench will produce the temper. Rapid cooling increases the compression forces on the surface and the tension forces inside the glass. The air stream is directed against the hot glass from arrays of fixed, reciprocation or rotating blast nozzles. As this cooling continues, it is important to extract heat uniformly from all surfaces and to sustain the quench long enough to prevent reheating of the glass surfaces from the still-hot glass core. A quenched condition will become stable when the glass is reduced to a temperature of approximately 400-600° F. The position, motion, and number of the air quenches to cool the glass will vary depending of the design of each fixture.

The sixth step is the grinding step 460. The only work that can be performed on tempered glass is grinding to reduce the width and length in certain fixtures to meet quality specifications.

The next step is the assembly step 470. Some of the parts of the toilet, urinal, and bidet are manufactured in different molds for safety reasons as discussed before. In this assembly step 470, the separate parts are joined. These parts are internal assemblies and will not affect the surface aesthetic or appearance of the fixtures.

After assembly, each fixture goes through a polishing step 480, wherein a glazer fires the glass and melts off the outermost layer, leaving it with a smooth, shiny finish. This step completes the manufacturing process for the present invention.

Now referring to FIG. 5, a table of a preferred glass composition with multiple embodiments of colorant agents 500 is shown. Numerous combinations of weight percentages may be batched to create the color and shading desired Factors determining selection include availability of compounds, cost of materials, and color desired. For example, for a green fixture, one combination may be the following.

| | |
|---|---|
| silica | 71% |
| soda ash | 14% |
| limestone | 11% |
| colorant (Chromium + 3) | 4% |
| Total % | 100% |

Referring next to FIG. 6, a table of a more preferred glass composition with multiple embodiments of colorant agents 600 is shown. Note that multiple compounds or elements can be used to create the identical color. Some compounds or elements may not be available or may be more expensive than others.

Finally, FIG. 7 shows a table of considerations for adding colorant agents 700.

Key novel features or advantages include manufacturing from glass. No one, to Applicants' knowledge, has made these large bathroom fixtures from glass. Another novel feature is the adding color in many different colors and shades. Still another unique feature is the darker shading of lower areas of toilets, urinals, and bidets by molding the fixtures to be thicker. Yet another novel feature of the present invention is the specific weight percentages of raw material and coloring agents.

Another advantage of the present invention is the inexpensive design. Because the bathrooms fixtures are produced in large numbers, the unit price is extremely inexpensive for any end user. Even given the different embodiments, the volumes would provide for inexpensive fixtures 100, 200, and 300 compared to the current list prices for the three major U.S. manufacturing firms.

Still another advantage of the present invention is the design flexibility. The dimensions of the fixtures may be changed to meet the needs of the end user and the specific application. Glass tubs, glass paper holders, glass towel holders, glass soap holders, glass sink pedestals, and glass faucets are just a few of possible fixtures that can be manufactured using the Applicants' novel invention.

Consequently, while the foregoing description has described the principle and operation of the present invention in accordance with the provisions of the patent statutes, it should be understood that the invention may be practiced otherwise as illustrated and described above and that various changes in the size, shape, and materials, as well as on the details of the illustrated construction may be made, within the scope of the appended claims without departing from the spirit and scope of the invention.

What is claimed is:

1. A method of operation of manufacturing a tempered glass bathroom fixture, wherein said method comprises the steps of:
batching,
melting,
glass pressing, wherein appropriate sized molds are used,
finishing,
tempering,
grinding,
final assembly,
and polishing.

2. A method of operation of a tempered glass bathroom fixture, according to claim 1, wherein said batching step comprises the step of:
preferably combining the following chemical compounds from the specified weight percentage ranges: silica sand (SiO₂) 50-75%, lead oxide (PbO) 0-30%, soda (Na₂O) 0-16%, Potash (K₂) 0-10%, soda ash (Na₂Co₃) 12-28%, limestone (CaCo₃) 5-15%, dolomite (MgCo₃) 5-12%, alumina-silicate 0-7%, salt cake 0-0.5%, and a colorant agent 0-4%.

3. A method of operation of a tempered glass bathroom fixture, according to claim 1, wherein said batching step further comprises the step of:
alternatively, and more preferably combining the following chemical compounds from the specified weight percentage ranges: silica sand (SiO₂) 50-95%, lead oxide (PbO) 0-40%, soda (Na₂O) 0-20%, Potash (K₂) 0-20%, soda ash (Na₂Co₃) 0-35%, limestone (CaCo₃) 0-20%, dolomite (MgCo₃) 0-20%, alumina-silicate 0-10%, salt cake 0-2%, and a colorant agent 0-7%.

4. A method of operation of a tempered glass bathroom fixture, according to claim 1, wherein said batching step further comprises the step of:
adding colorant, wherein, and by way of example, for a turquoise shade of a bathroom fixture, copper oxide (Cu₂) is added in the weight percentage 0-5%.

5. A method of operation of a tempered glass bathroom fixture, according to claim 5, wherein said adding step further comprises the step of:
alternatively, and preferably adding a colorant, wherein, and by way of example, for a turquoise shade of a bathroom fixture, copper oxide (Cu₂) is added in the weight percentage 0-3%.

6. A method of operation of a tempered glass bathroom fixture, according to claim 1, wherein said finishing step further comprises the steps of:
joining, wherein two or more parts of one fixture manufactured from different molds, are joined,
detailing edges and union areas,
drilling, or
alternatively, cutting where necessary, and
coating, wherein said fixtures are provided with a surface coat applied when the fixtures are still hot, and further wherein said fixtures are more resistant to scratches.

7. A method of operation of a tempered glass bathroom fixture, according to claim 1, wherein said tempering step further comprises the steps of:
vertical tempering, wherein tongs are used to suspend said glass fixture from a top edge, and further wherein said fixture moves vertically through a furnace. or alternatively, horizontal tempering, wherein said glass fixture moves through said furnace on stainless steel or ceramic rollers, and
cooling, wherein an air jet system rapidly cools said fixture in order to temper said fixture, and further wherein an air stream is directed against hot glass from arrays of fixed, reciprocating, or rotating blast nozzles uniformly onto all fixture surfaces simultaneously, thereby producing the temper at a temperature of approximately 400-600° F.

8. A method of operation of manufacturing a tempered glass fixture according to claim 1, wherein said fixture is a bathroom toilet, and further wherein said method comprises the steps of:
batching,
melting,
glass pressing, wherein appropriate sized molds are used to thicken a lower portion of a bowl in said bathroom toilet, and further wherein said thickened portion is translucent, and further wherein said thickened portion provides a darker color shading compared to an upper portion of said toilet,
finishing,
tempering,
grinding,
final assembly,
and polishing.

9. A method of operation of manufacturing a tempered glass fixture according to claim 1, wherein said fixture is a bathroom urinal, and further wherein said method comprises the steps of:
batching,
melting,
glass pressing, wherein appropriate sized molds are used to thicken a lower portion of a bowl in said bathroom urinal, and further wherein said thickened portion is translucent, and still further wherein said thickened portion provides a darker color shading compared to an upper portion of said urinal,
finishing,
tempering,
grinding,
final assembly,
and polishing.

10. A method of operation of manufacturing a tempered glass fixture according to claim 1, wherein said fixture is a bathroom bidet, and further wherein said method comprises the steps of:
batching,
melting,
glass pressing, wherein appropriate sized molds are used to thicken a lower portion of a bowl in said bathroom bidet, and further wherein said thickened portion is translucent, and still further wherein said thickened portion provides a darker color shading compared to an upper portion of said bidet,
finishing,
tempering,
grinding,
final assembly,
and polishing.
